(19) United States
(12) Patent Application Publication
(10) Pub. No.: US 2010/0042582 A1
(43) Pub. Date: Feb. 18, 2010

(54) SYSTEM AND METHOD FOR IDENTIFICATION OF APPLICATION INTERDEPENDENCY

(75) Inventors: Rajan Aggarwal, Frisco, TX (US); Walter P. Schortmann, Plano, TX (US); Thomas W. Johnson, Denton, TX (US); Adam J. Hardin, Collinswood (AU); Srinivasan G. Embar, Plano, TX (US)

Correspondence Address: HEWLETT-PACKARD COMPANY;Intellectual Property Administration, P.O. Box 272400, Fort Collins, CO, 80527-2400, US

(73) Assignee: Electronic Data Systems Corporation, Plano, TX (US)

(21) Appl. No.: 12/190,509

(22) Filed: Aug. 12, 2008

(51) Int. Cl. G06F 7/06; G06F 17/30

(52) U.S. Cl. 707/3; 707/E17.014

(57) ABSTRACT

A method for identification of application interdependency. The method includes receiving dependency data in a Application Interdependency Identification Tool (AIIT) system, and identifying a plurality of applications and dependency relationships corresponding to the dependency data by a dependency engine. The method also includes displaying the dependency data according to the identified applications and dependency relationships. There is also an AIIT system including a dependency engine and a dependency database. The AIIT system is configured to receive dependency data. The dependency engine is configured to identify a plurality of applications and dependency relationships corresponding to the dependency data and display the dependency data according to the identified applications and dependency relationships.

### TECHNICAL FIELD

The present disclosure is directed, in general, to analysis of software application infrastructure.

### BACKGROUND OF THE DISCLOSURE

In a complex networked environment of applications, it is common for any one application to be dependent on multiple other applications for its basic functioning.

### SUMMARY OF THE DISCLOSURE

One embodiment includes a method for identification of application interdependency. The method includes receiving dependency data in an Application Interdependency Identification Tool (AIIT) system, and identifying a plurality of applications and dependency relationships corresponding to the dependency data by a dependency engine. The method also includes displaying the dependency data according to the identified applications and dependency relationships.

Another embodiment includes an AIIT system including a dependency engine and a dependency database. The AIIT system is configured to receive dependency data. The dependency engine is configured to identify a plurality of applications and dependency relationships corresponding to the dependency data and display the dependency data according to the identified applications and dependency relationships.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of an AIIT system in accordance with a disclosed embodiment; and

FIG. 3 depicts a flowchart of a process in accordance with a disclosed embodiment.

### DETAILED DESCRIPTION

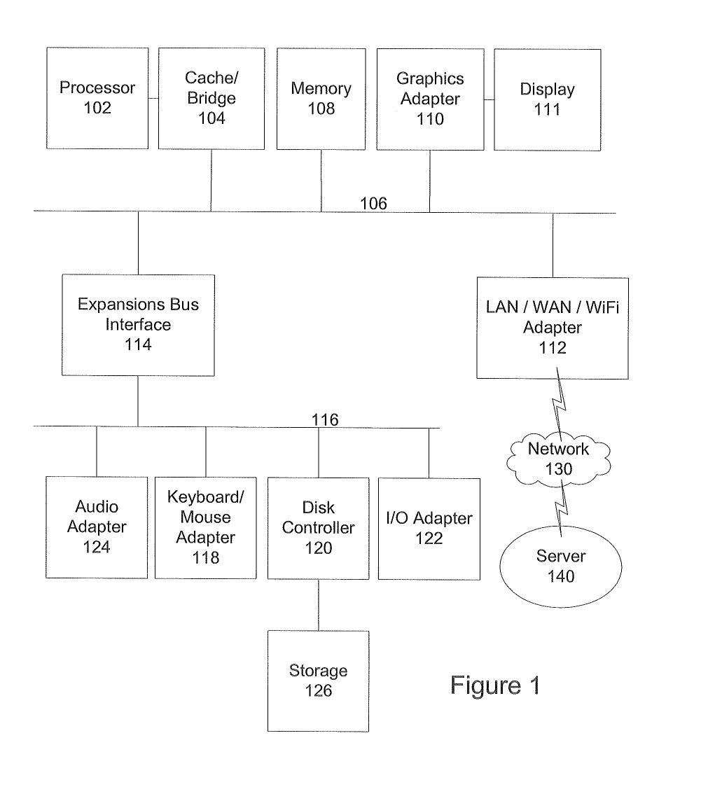

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In a complex networked environment of applications, any one application can be dependent on multiple other applications for its basic functioning. It becomes critical that all interdependencies are clearly understood and known so that the application can be properly supported.

Many Service Level Agreements between service providers and customers include specific provisions regarding the percentage uptime of any application or business function (application availability) as well as mean time to restore (MTTR) an application or business function when it has incidents or problems associated with it.

The software application infrastructure can influence the severity of any problems or changes to installed applications. The disclosed embodiments include an Application Interdependency Identification Tool (AIIT) system that can list and depict the type of linkages that exist between the applications to determine the affect of one of the applications being down or partially functioning on rest of the applications within the linkage. One application may depend on a second application, which may in turn depend on a third application, and there may be multiple ones of each of these types of dependencies. Based on these linkages, some applications are “upstream” to a second application (i.e., the first application depends on the second application) and some applications are “downstream” from a second application (i.e., the second application depends on the first application).

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary in particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

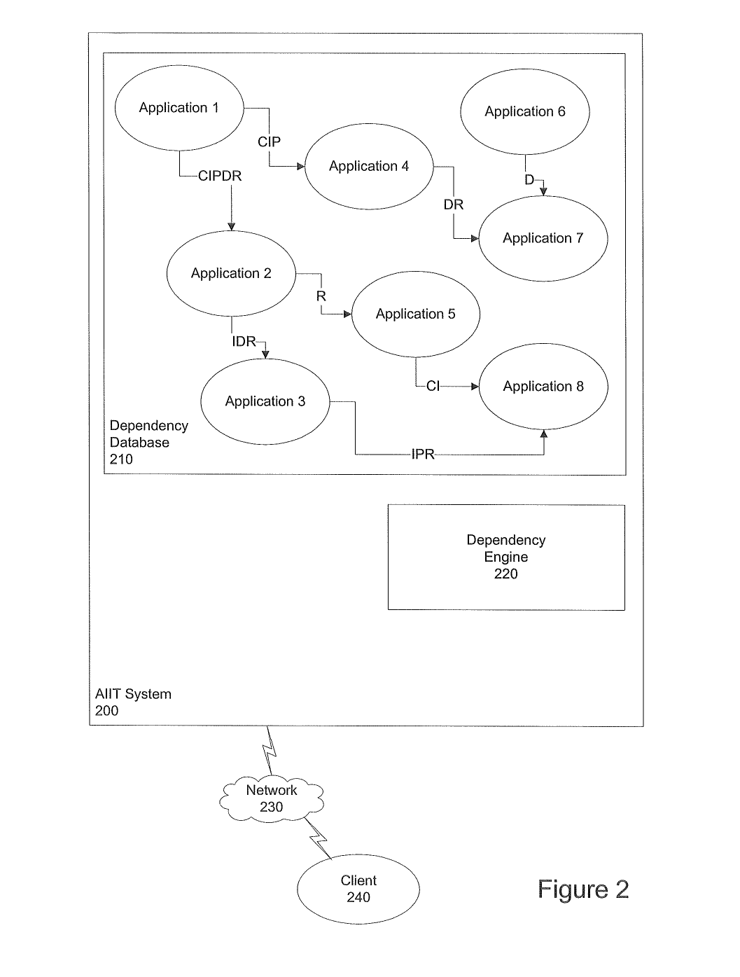

FIG. 2 depicts a block diagram of an AIIT system in accordance with a disclosed embodiment. AIIT system 200 can be implemented as a data processing system 100, described above, and also includes a dependency engine 220 and a dependency database 210. Dependency engine 220 can be a dedicated controller in some embodiments, and can be implemented using processor 102 in some embodiments. AIIT system 200 is capable of storing and displaying dependency data, interacting with users, and has additional functions and capabilities as described herein. Dependency database 210 can be maintained, e.g., in storage 126 or memory 108.

In some stand-alone embodiments, interactions with users are performed directly by AIIT system 200. In other embodiments, the AIIT system can also, or alternately, interact with users via client data processing system 240 and network 230. In some embodiments, a user of client 240 can use a standard thin-client browser, such as the INTERNET EXPLORER browser or the MOZILLA FIREFOX browser, to communicate over network 230 with AIIT system 200. While only a single client system 240 is shown in this figure, those of skill in the art will recognize that in some embodiments, multiple clients 240 will communicate with AIIT system 200 to allow users to perform the interactions described herein.

The disclosed embodiments aid in identifying, documenting and querying these dependencies in a very user friendly way, in a easy to understand manner so that the support personnel can use it to manage day to day Incident, Problem, Change functions related to a particular application.

In some embodiments, the Application Interdependency Identification Tool (AIIT) system disclosed herein visually identifies or lists dependencies between the applications in five different categories. These include:

Client Data dependency (D), which depicts any dependency on a client and/or system data source required by a tool in order to deliver a client specific function or service.

Component dependency (C), which depicts the dependencies of a tool on another tool's components (distributed or non distributed) or individual components specifically designed to perform unique function.

Interface dependency (I), which depicts an interface or an integration that must be in place between relevant installed tools before becoming fully functional.

Runtime dependency (R), which depicts that there is a direct or indirect dependency during run time that could impact the functionality of a given tool.

Production dependency (P), which depicts the dependency of a tool being upgraded on another existing installed tool, client data, and/or system data that may impact its own functionality.

Conventionally, when an application is down or partially functioning, it is difficult to determine the consequences to other interdependent applications or components. Typically, the consequences cannot be appreciated until other failures have occurred.

Dependency database 210, as illustrated in FIG. 2, shows dependency data including multiple exemplary applications 1-8 and the dependency relationships between them. Each dependency relationship is identified as one or more of the dependency categories identified above. For example, Application 2 depends on downstream Application 3 for Interface dependency (I), Client Data dependency (D), and Runtime dependency (R). Application 2 is also depends on downstream Application 5 for Runtime dependency (R).

Application 1 is upstream of Application 2. Application 1 depends on downstream Application 2 for Component dependency (C), Interface dependency (I), Production dependency (P), Client Data dependency (D), and Runtime dependency (R).

Of course, the example of FIG. 2 does not limit the number of applications or the types of dependencies in any implementation. Further, while the applications and there dependencies are depicted graphically as part of dependency database 210 in this example for illustrative purposes, those of skill in the art will recognize that the data can actually be stored using any number of conventional database formats. The graphic example of FIG. 2 indicates how the interdependencies can be displayed to a user, e.g. on a display 111.

In some embodiments, the dependency data can be displayed in other formats, e.g., in a simple text format. For example:
APPLICATION 2
   UPSTREAM
      APPLICATION 1—CIPDR
   DOWNSTREAM
      APPLICATION 3—IDR
      APPLICATION 5—R

The disclosed embodiments display selected interdependencies and thereby enable a user to quickly identify how a specific application failure affects other applications and the extent of severity caused in terms of dependencies to upstream and downstream applications in the linkages. Once these interdependencies are identified, the system can rapidly and proactively notify other application specialists that are affected by failure so they can take appropriate action, e.g. by telephone, network notification, email, text message, or otherwise, via network 130/230, I/O adapter 122, or otherwise.

As another example, often after the implementation of network and firewall changes, an application completely inaccessible to the client systems over a network. The reason is because the network and firewall teams do not have complete knowledge of the dependency that exists between the applications and inadvertently cut off some of the linkages between the applications. The disclosed embodiments enable network managers to review dependencies in the planning phase of the change and taking appropriate precautions and communication.

For planning/notification of changes and maintenance activities for a particular application itself one needs to determine whether the change will have any effect on upstream and downstream applications and in what way. The AIIT system plays a critical role in planning the changes right so that change to one application does not adversely impact other applications and both the upstream and down stream applications are aware of what actions to take as a result of the change to an application.

Another use of AIIT system is in the area of deploying new clients. AIIT system helps to identify the client data flows and interdependency amongst applications in relation to common data flows. AIIT system will identify the data flows so that the deployment teams can ensure proper data is being captured.

As an additional benefit, proper utilization of AIIT system reduces operating costs by helping in identifying these dependencies upfront and preventing costly mistakes and client dissatisfaction.

In various embodiments, AAIT system provides a real time visualization tool that helps in detecting potential or existing problems quickly and notifies appropriate teams automatically thus dramatically decreasing the time to respond and fix a problem. This application with the knowledge of the various linkages between applications can help increase knowledge in performing intelligent trouble shooting.

With the introduction of each additional tool into this network will spawn additional types of dependency between tools. This scenario gets very complex as networks may host dozens or hundreds of applications, any of which may depend on others.

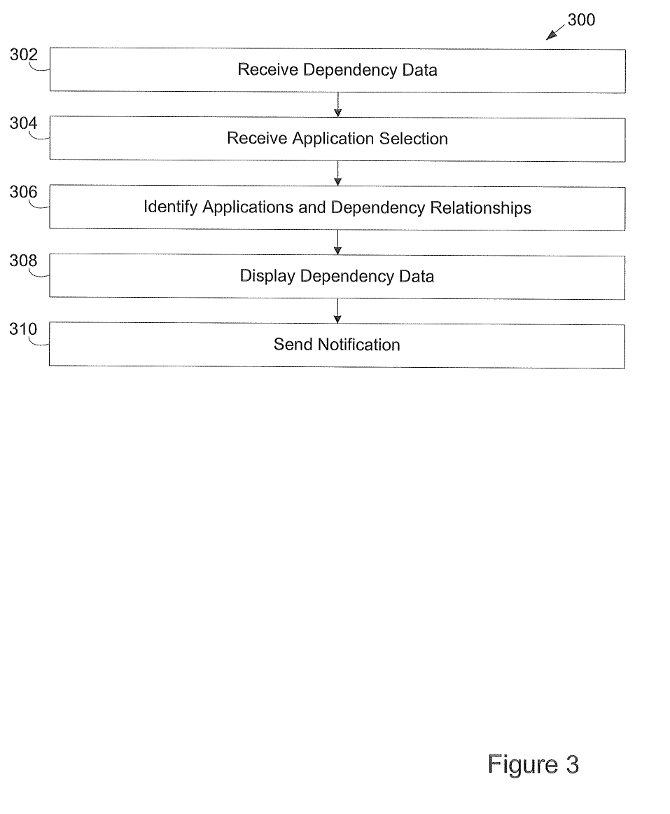

FIG. 3 depicts a flowchart of a process 300 in accordance with a disclosed embodiment.

The AIIT system 200 receives dependency data (block 302). This step can be accomplished by loading pre-existing dependency data from dependency database 210 by the dependency engine 220, or can be accomplished by receiving dependency data via an interaction with a user either directly or over a network, and storing this dependency data in the dependency database. Such a process can also be used for modifying pre-existing dependency data.

The dependency engine optionally receives and stores a selection of one or more applications from a user (block 304). This can also function as an indication of one or more failed or failing applications, if such a selection is received from the user.

The dependency engine identifies the applications and dependencies according to the dependency data (block 306).

The dependency engine displays the dependency data (block 308). If one or more applications were selected by a user, then those applications are displayed, along with their upstream and downstream applications, and the dependency relationships between them. If a graphical display is used, colors or shapes could be used to distinguish the applications. For example, a selected application could be displayed in a first color or shape, its downstream applications could be displayed in a second color or shape, and its upstream applications could be displayed in a third color or shape. If no applications were selected, then all applications and relationships can be displayed, or some subset of all applications and dependency relationships. Displaying the dependency data can be on the local data processing system, or can include sending the dependency data to another data processing system over a network for display on that system.

The dependency engine optionally sends one or more notifications of upstream and/or downstream applications (applications with a direct dependency relationship with the selected application) of any selected application (block 310). Upstream applications, dependent on a selected application, are particularly advantageous for such notifications, since they depend on a selected application, which can be a failed application indicated by the user.

Of course, once applications with a direct dependency relationship with a selected application are identified, it may be useful to then determine further dependency relationships of each of those applications, to identify other potential failures that could be related to the originally selected application.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for identification of application interdependency, comprising:
receiving dependency data in a Application Interdependency Identification Tool (AIIT) system;
identifying a plurality of applications and dependency relationships corresponding to the dependency data by a dependency engine; and
displaying the dependency data according to the identified applications and dependency relationships.

2. The method of claim 1, further comprising:
receiving, from a user, a selection of at least one application of the plurality of applications.

3. The method of claim 2, wherein displaying the dependency data comprises displaying applications with a direct dependency relationship with the selected application.

4. The method of claim 3, further comprising sending a notification corresponding to the applications with a direct dependency relationship with the selected application.

5. The method of claim 3, wherein the selected application is displayed using a first color, and the applications with a direct dependency relationship with the selected application are displayed using a color different than the first color.

6. The method of claim 1, wherein the dependency relationships are identified as one or more of a Component dependency (C), an Interface dependency (I), a Production dependency (P), a Client Data dependency (D), and a Runtime dependency (R).

7. The method of claim 1, wherein displaying the dependency data includes transmitting the dependency data over a network.

8. An Application Interdependency Identification Tool (AIIT) system comprising a dependency engine and a dependency database,
wherein the AIIT system is configured to receive dependency data, and
wherein the dependency engine is configured to identify a plurality of applications and dependency relationships corresponding to the dependency data and display the dependency data according to the identified applications and dependency relationships.

9. The AIIT system of claim 8,wherein the dependency engine is also configured to receive, from a user, a selection of at least one application of the plurality of applications.

10. The AIIT system of claim 9, wherein displaying the dependency data comprises displaying applications with a direct dependency relationship with the selected application.

11. The AIIT system of claim 10, wherein the dependency engine is also configured to send a notification corresponding to the applications with a direct dependency relationship with the selected application

12. The AIIT system of claim 10, wherein the selected application is displayed using a first color, and the applications with a direct dependency relationship with the selected application are displayed using a color different than the first color.

13. The AIIT system of claim 8, wherein the dependency relationships are identified as one or more of a Component dependency (C), an Interface dependency (I), a Production dependency (P), a Client Data dependency (D), and a Runtime dependency (R).

14. The AIIT system of claim 8, wherein displaying the dependency data includes transmitting the dependency data over a network.

15. A machine-useable medium encoded with machine-useable and executable instructions, comprising:
instructions for receiving dependency data in an Application Interdependency Identification Tool (AIIT) system;
identifying a plurality of applications and dependency relationships corresponding to the dependency data by a dependency engine; and
displaying the dependency data according to the identified applications and dependency relationships.

16. The machine-useable medium of claim 15, further comprising:
instructions for receiving, from a user, a selection of at least one application of the plurality of applications.

17. The machine-useable medium of claim 16, wherein displaying the dependency data comprises displaying applications with a direct dependency relationship with the selected application.

18. The machine-useable medium of claim 17, further comprising instructions for sending a notification corresponding to the applications with a direct dependency relationship with the selected application.

19. The machine-useable medium of claim 17, wherein the selected application is displayed using a first color, and the applications with a direct dependency relationship with the selected application are displayed using a color different than the first color.

20. The machine-useable medium of claim 15, wherein the dependency relationships are identified as one or more of a Component dependency (C), an Interface dependency (I), a Production dependency (P), a Client Data dependency (D), and a Runtime dependency (R).

21. The machine-useable medium of claim 15, wherein displaying the dependency data includes transmitting the dependency data over a network.
